(19) United States
(12) Patent Application Publication
(10) Pub. No.: US 2025/0363889 A1
(43) Pub. Date: Nov. 27, 2025

(54) MONITORING DEVICE WITH INTERRUPTION DETECTION

(71) Applicant: The MITRE Corporation, McLean, VA (US)

(72) Inventors: Teri Li Hoffman-Boswell, Vienna, VA (US); Maxim Khanin, Fairfax, VA (US); Clifton Scott Dudley, Bedford, MA (US); Joseph Lavalley, Dedham, MA (US); Jack F. Palladino, Alexandria, VA (US)

(73) Assignee: The MITRE Corporation, McLean, VA (US)

(21) Appl. No.: 19/216,077

(22) Filed: May 22, 2025

Related U.S. Application Data
(60) Provisional application No. 63/650,624, filed on May 22, 2024.

(51) Int. Cl. G08C 19/00; G08B 13/14

(52) U.S. Cl. CPC G08C 19/00; G08B 13/14

(57) ABSTRACT

Disclosed herein are a system, method, and computer program product embodiments for determining that a monitoring device has been tampered with or removed from a limb of a wearer of the monitoring device. For example, a determination may be made that the monitoring device has been tampered with or removed from a limb of a wearer of the monitoring device. In response to detecting that the monitoring device has been tampered with or removed from the limb of the wearer of the monitoring device, transmission of a signal from a beacon of the monitoring device may be halted, an indication indicating that the monitoring device has been tampered with or removed from the limb of the wearer of the monitoring device may be stored in a memory of the monitoring device, and re-transmission of the signal may be prevented while the indication is stored in the memory.

### CROSS-REFERENCE TO RELATED APPLICATION

This application claims the benefit of U.S. Provisional Patent Application No. 63/650,624, filed on May 22, 2024, the contents of which are incorporated herein by reference in its entirety.

### BACKGROUND

Personal monitoring devices are used to monitor the position and movements of individuals of interest. Personal monitoring devices may be utilized for various use cases, including, but not limited to, child monitoring, elder monitoring, and law enforcement monitoring (e.g., to monitor parolees, bailees, and persons subject to house arrest). Such monitoring devices have known problems and/or limitations, including, but not limited, to signal interference, battery life, cost, and lack of tamperproof circuitry.

### SUMMARY

Provided herein are system, apparatus, article of manufacture, method and/or computer program product embodiments, and/or combinations and sub-combinations thereof, for determining that a monitoring device has been tampered with or removed from a limb of a wearer of the monitoring device. For example, a determination may be made that the monitoring device has been tampered with or removed from a limb of a wearer of the monitoring device. In response to detecting that the monitoring device has been tampered with or removed from the limb of the wearer of the monitoring device, transmission of a signal from a beacon of the monitoring device may be halted, an indication indicating that the monitoring device has been tampered with or removed from the limb of the wearer of the monitoring device may be stored in a memory of the monitoring device, and re-transmission of the signal may be prevented while the indication is stored in the memory.

In some embodiments, in response to detecting that the monitoring device has been tampered with or removed from the limb of the wearer of the monitoring device, an output device coupled to the monitoring device is activated.

In some embodiments, the output device comprises at least one of a light emitting diode (LED), a vibration unit, or a speaker.

In some embodiments, the beacon is a Bluetooth Low Energy (BLE)-based beacon, and wherein the signal is a BLE-based signal.

In some embodiments, the signal comprises an identifier that uniquely identifies the monitoring device.

In some embodiments, detecting that the monitoring device has been tampered with or removed from the limb of a wearer of the monitoring device comprises detecting that data received from at least one of one or more motion sensors or one or more physiological sensors meets a predetermined threshold.

In some embodiments, detecting that the monitoring device has been tampered with or removed from the limb of a wearer of the monitoring device comprises determining that a component of the monitoring device has been removed.

In some embodiments, the component comprises at least one of a battery of the monitoring device or a beacon of the monitoring device.

In some embodiments, detecting that the monitoring device has been tampered with or removed from the limb of a wearer of the monitoring device comprises determining that a conductive wire that runs along a strap of the monitoring device has been cut.

In some embodiments, a counter value stored in the memory is incremented each time the monitoring device is activated.

### BRIEF DESCRIPTION OF THE DRAWINGS

The accompanying drawings are incorporated herein and form a part of the specification.

FIG. 1 depicts an example monitoring device, according to some embodiments.

FIG. 2 is a block diagram of a system configured to monitor a user, according to some embodiments.

FIG. 3 depicts a monitoring device comprising tamper-avoidance wires, according to some embodiments.

FIG. 4 is a block diagram of a system for monitoring a user via a monitoring device, according to some embodiments.

FIG. 5 depicts an example graphical user interface (GUI) screen for monitoring a wearer of a monitoring device, according to some embodiments.

FIG. 6 is a flowchart for a method for determining that a monitoring device has been tampered with or removed from a limb of a wearer of the monitoring device, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The embodiments described herein are directed to monitoring a monitoring device comprising interruption detection that prevents a wearer from re-enabling signal transmission after removal of the monitoring device. In particular, provided herein are a system, apparatus, device, method and/or computer program product embodiments, and/or combinations and sub-combinations thereof, for determining that a monitoring device has been tampered with or removed from a limb of a wearer of the monitoring device. For example, a determination may be made that the monitoring device has been tampered with or removed from a limb of a wearer of the monitoring device. In response to detecting that the monitoring device has been tampered with or removed from the limb of the wearer of the monitoring device, transmission of a signal from a beacon of the monitoring device may be halted, an indication indicating that the monitoring device has been tampered with or removed from the limb of the wearer of the monitoring device may be stored in a memory of the monitoring device, and re-transmission of the signal may be prevented while the indication is stored in the memory.

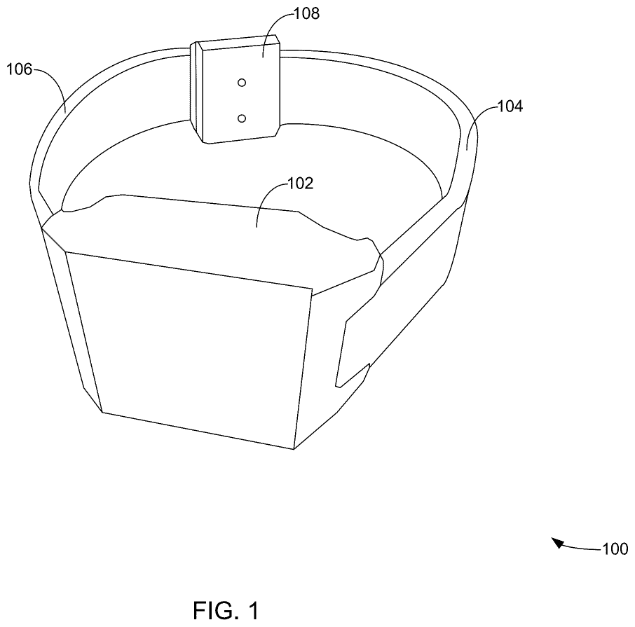

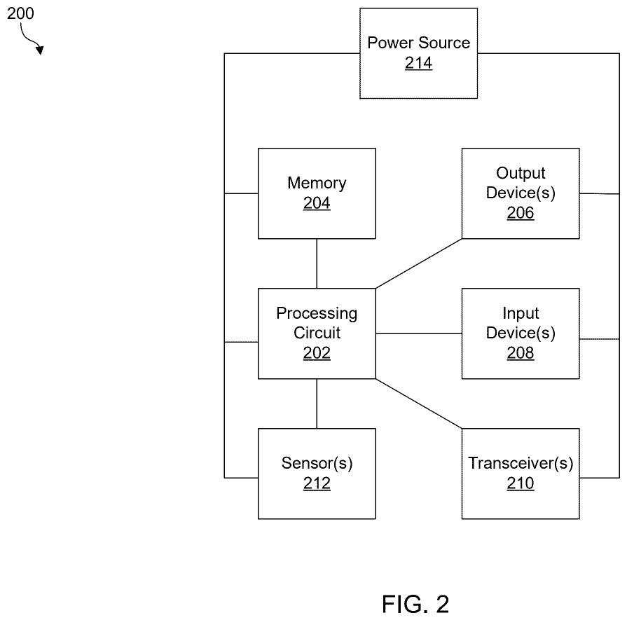

FIG. 1 shows an example monitoring device 100, according to some embodiments. As shown in FIG. 1, monitoring device 100 may comprise a body 102, a first strap portion 104, a second strap portion 106, and a clasping mechanism 108. Body 102 may be configured to house various components, including, one or more power sources (e.g., a battery), one or more processing circuits (e.g., a processor, a controller, a microcontroller, etc.), one or more storage devices, one or more memories, one or more receivers, one or more transmitters, one or more transceivers, one or more sensors, etc. Additional details regarding such components are described below with reference to FIG. 2.

Each of first strap portion 104 and second strap portion 106 comprise a proximal end and distal end. Each of the proximal ends of first strap portion 104 and second strap portion 106 are configured to be coupled to body 102 (e.g., via one or more pins, one or more screws, one or more levers, an adhesive, etc.).

Clasping mechanism 108 may be configured to couple distal ends of first strap portion 104 and second strap portion 106 to one another, such as around a limb (e.g., a wrist or ankle) of a wearer of monitoring device 100. Clasping mechanism 108 may be any suitable clasping mechanism allowing distal ends of first strap portion 104 and second strap portion 106 to be joined together, so as to be capable of being joined, disjoined, and/or rejoined with one another. For example, clasping mechanism 108 may comprise a buckle, a button, a fastener, such as a hook and loop fastener, a pin and loop fastener, a tongue and groove fastener, a latch fastener, a clip, a tie, a screw with corresponding screw threads, a cam, and/or any other coupling mechanism sufficient for joining the distal ends of first strap portion 104 and second strap portion 106 together. In an embodiment, clasping mechanism 108 may comprise a tamper-resistant locking mechanism configured to prevent removal of monitoring device 100 from the limb of the wearer. Such a locking mechanism may comprise a lock that is secured using one or more tamper-resistant (or security) screws that require a specialized tool (e.g., a specialized screwdriver) for removal thereof.

One or more of body 102, first strap portion 104, and/or second strap portion 106 may be made from one or more materials, including, but not limited to, rubber, synthetic rubber, silicone, polyamide (Nylon), woven fabric, webbing, leather, metal, etc. In an embodiment, one or more of body 102, first strap portion 104, and/or second strap portion 106 may be manufactured using three-dimensional (3D) printing techniques, for example, using filament extrusion or milled acrylonitrile butadiene styrene (ABS)-based techniques. One or more of body 102, first strap portion 104, and/or second strap portion 106 may be made of a ruggedized, hydrophobic, shockproof, and/or waterproof material. In addition, body 102 may be designed to be completely waterproof to prevent the complete intrusion of water in the interior of body 102.

FIG. 2 is a block diagram of a system 200 configured to monitor a user, according to some embodiments. System 200 (or any of components thereof) may be included in body 102, first strap portion 104, and/or second strap portion 106 of monitoring device 100, as shown above with respect to FIG. 1. System 200 may comprise a processing circuit 202, a memory 204, one or more output device(s) 206, one or more input device(s) 208, one or more transceivers 210, one or more sensor(s) 212, and/or a power source 214. In some embodiments, memory 204 may be incorporated within processing circuit 202. Processing circuit 202 may comprise a processor (e.g., a central processing unit (CPU), a microcontroller, a controller, and/or the like). Memory 204 may comprise a non-volatile memory, such as, but not limited to, an electrically erasable programmable read-only memory (EEPROM), flash memory, a ferroelectric random access memory (FRAM), and/or the like. Output device(s) 206 may include, but are not limited to, a light emitting diode (LED), a speaker, a vibration unit, etc. Input device(s) 208 may include, but are not limited to, a camera and/or one or more input interfaces via which a wearer may provide input (e.g., buttons, a touchscreen, a microphone, etc.). Transceiver(s) 210 may comprise one or more antenna(s), for example, a Bluetooth-based antenna, a Wi-Fi-based antenna, and/or a Near Field Communication (NFC)-based antenna. Sensor(s) 212 may include, but are not limited to, one or more motion sensors (e.g., a pedometer, an accelerometer, a gyroscope, etc.) and/or one or more physiological or biometric sensors (e.g., a temperature sensor, a heart rate sensor, a blood pressure sensor, an oxygen sensor, etc.). Power source 214 may be configured to provide power to one or more of the components of system 200 (e.g., processing circuit 202, memory 204, output device(s) 206, input device(s) 208, transceiver(s) 210, and/or sensor(s) 212). Power source 214 may comprise a rechargeable or non-rechargeable battery having a particular capacity (e.g., 265 milliampere-hours (mAh), 550 mAh, 1 Ah, etc.). In an embodiment, power source 214 is a primary cell and not a secondary (e.g., rechargeable) cell. The primary cell may be capable of 1.5 to 2 years of operation depending on its capacity. In an embodiment, one or more of components of system 200 may be included on a single substrate (e.g., a printed circuit board (PCB)).

Processing circuit 202 may be configured to detect whether usage of monitoring device 100 has been interrupted. For example, processing circuit 202 may determine a wearer of monitoring device 100 has removed monitoring device 100. In one example, motion sensor(s) of sensor(s) 212 may collect various data related to the wearer's movement (e.g., speed, velocity, direction, etc.). Processing circuit 202 may analyze such data and determine whether the wearer's movement is uncharacteristic of the wearer. For instance, processing circuit 202 may compare such data to one or more thresholds. If the data meets the threshold(s) (e.g., exceeds, falls below, etc.), processing circuit 202 may determine that the wearer is no longer wearing monitoring device 100. In another example, physiological sensors of sensor(s) 212 may collect various physiological measurements of the wearer (e.g., temperature, heart rate, a blood pressure, an oxygen levels, etc.). Such measurements may be provided to processing circuit 202. Processing circuit 202 may compare such measurements to one or more thresholds. If the measurements meet the threshold(s) (e.g., exceeds, falls below, etc.), processing circuit 202 may determine that the wearer is no longer wearing monitoring device 100.

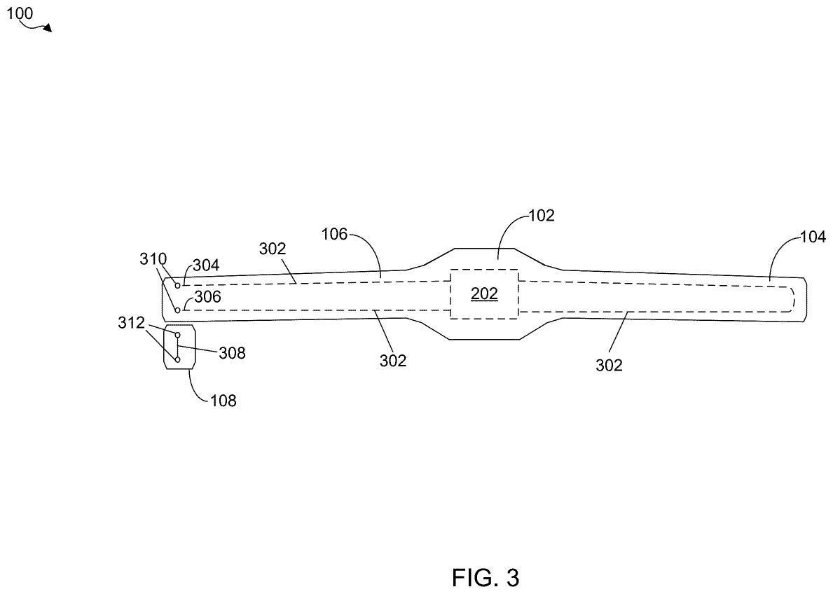

In a further example, an object and/or material embedded with first strap portion 104 and/or second strap portion 106 may be utilized to detect whether a wearer is no longer wearing monitoring device. Examples of such an object and/or material include, but are not limited to, tamper-avoidance wires, a relatively thin PCB or flexible substrate (e.g., thinner than the thickness of first strap portion 104 and/or second strap portion 106), etc. For instance, FIG. 3 depicts a monitoring device 300 comprising tamper-avoidance wires, according to some embodiments. As shown in FIG. 3, first strap portion 104 and a second strap portion 106 may house one or more tamper-avoidance wires 302 embedded therein and extending the length of first strap portion 104 and second strap portion 106, from the proximal end to the distal end respectively thereof. Wires 302 may be a tensile-strength cable. As further shown in FIG. 3, wires 302 may be communicatively coupled to processing circuit 202. First strap portion 104 may house a first end 304 and a second end 306 of wire(s) 302. A conductive connector 308 (e.g., a wire) in locking mechanism 108 may be configured to conductively couple first end 304 with second 306 upon locking (e.g., coupling) first strap portion 104 with second strap portion 106 via locking mechanism 108. Locking mechanism 108 may be locked in placed via one or more security screws placed within threaded apertures 312 of locking mechanism 108 and/or threaded apertures 310 of second strap portion 106.

When conductive connector 308 electrically couples the distal end of first strap portion 104 with the distal end of second strap portion 106, processing circuit 202 may transmit a signal via wire(s) 302 and sample the signal via wires 302. In an embodiment, processing circuit 202 may periodically transmit and sample the signal via wires 302. Processor circuit 202 may compare the sampled signal to a reference signal or a threshold value. When first strap portion 104 and/or second strap portion 106 is bent, broken or otherwise damaged, the strength of the signal sampled by processor circuit 202 may be attenuated, and therefore, may drop below the reference signal or threshold value. Upon detecting such a drop, processor circuit 202 may determine that monitoring device 100 has been tampered with and/or that the wearer has removed monitoring device 100.

Referring again to FIG. 2, in yet a further example, processing circuit 202 may be configured to determine whether one or more components (e.g., power source 214, transceiver(s) 210, etc.) of monitoring device 100 have been removed. For instance, sensor(s) 212 may comprise sensor(s) configured to measure a voltage and/or current provided to such component(s) via wire(s) that couple such component(s) to power source 214 and/or processing circuit 202. Such sensor(s) include, but are not limited to, a shunt resistor, a current transformer, a Hall effect sensor, and/or the like. If such component(s) are removed, a drop in voltage and/or current would be detected. Upon detecting such a drop in voltage and/or current, processing circuit 202 may determine that monitoring device 100 has been tampered with.

It is noted that monitoring device 100 may implement any combination of the tamper detection techniques described herein. In response to detecting that a wearer is no longer wearing or has tampered with monitoring device 100, one or more actions may be performed by processing circuit 202. For instance, processing circuit 202 may activate at least one of a speaker and/or an LED of output device(s) 206. Processing circuit 202 may also cause transceiver(s) 210 to stop transmitting one or more signals. An entity configured to monitor such signal(s) (e.g., an entity configured to monitor the wearer via monitoring device 100) may determine that monitoring device 100 has been removed and/or tampered with upon no longer detecting the signal(s) that transceiver(s) 210 are configured to transmit. Processing circuit 202 may also store an indication in memory 204 that indicates that monitoring device 100 has been removed by the user and/or tampered with. Processing circuit 202 may be configured to instruct transceiver(s) 210 to resume the transmission of the signal(s) only when the indication has been reset (e.g., by the manufacturer of monitoring device 100 or an entity authorized to reset the indication). This advantageously prevents the wearer from re-activating monitoring device 100 and placing monitoring device 100 on another person or moving object to mislead an entity monitoring the wearer. Memory 204 may also store one or more counter values. For example, processing circuit 202 may increment a first counter value of the counter value(s) each time monitoring device 100 has been powered. In another example, processing circuit 202 may increment a second counter value of the counter value(s) each time a power source (e.g., power source 214) is replaced in monitoring device 100. The counter value(s) may be utilized as another means to determine whether monitoring device 100 has been tampered with. For instance, in a scenario where a wearer manages to re-activate (e.g., power on) and/or replace the power source of monitoring device 100, the respective counter value(s) will be incremented, thereby indicating the number of times monitoring device 100 was re-activated. The counter value(s) may be stored in configuration registers of monitoring device 100, which may be readable to determine the number of times monitoring device 100 was re-activated. Counter value(s) that are above a predetermined threshold (e.g., 1) may be indicative that monitoring device 100 has been tampered with.

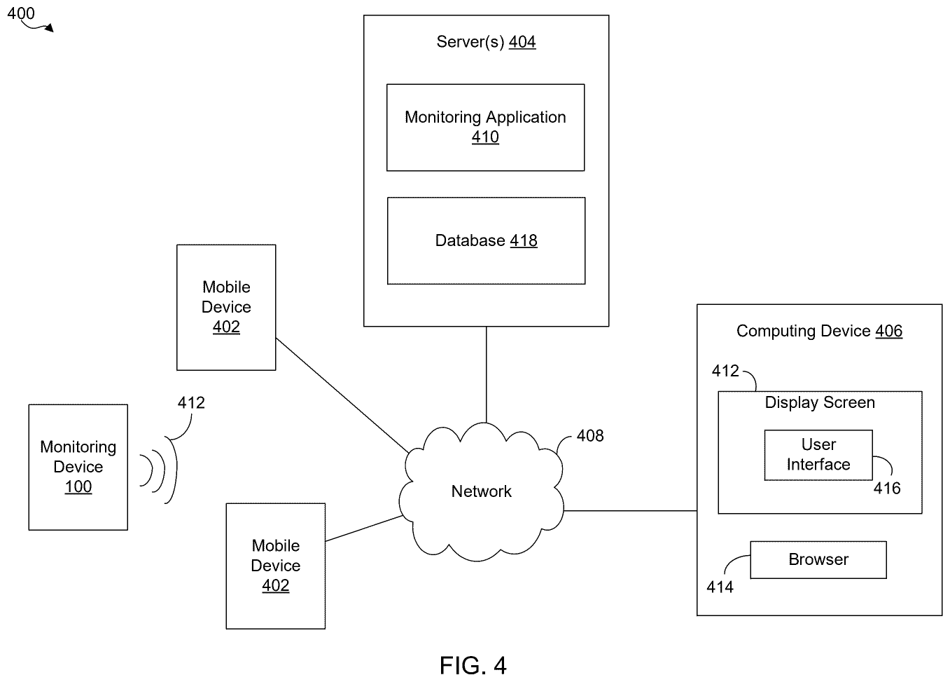

FIG. 4 is a block diagram of a system 400 for monitoring a user via a monitoring device, according to some embodiments. As shown in FIG. 4, system 400 includes monitoring device 100, one or more mobile devices 402, one or more server(s) 404, and a computing device 406. Server(s) 404, computing device 406, and mobile devices 402 may be communicatively coupled to each other via a network 408. Network 408 may comprise one or more networks such as local area networks (LANs), wide area networks (WANs), enterprise networks, the Internet, etc., and may include one or more of wired and/or wireless portions.

In an embodiment, one or more of transceiver(s) 210 of monitoring device 100 comprise a beacon that wirelessly transmits a signal 412. Signal 412 may comprise an identifier that uniquely identifies monitoring device 100. The identifier may be encrypted to protect the privacy of the wearer of monitoring device 100. Mobile device(s) 404 in the range of reception of signal 412 may detect signal 412. Mobile device(s) 404 may triangulate the location of monitoring device 100 based on the signal strength of signal 412 detected by mobile device(s) 404. Mobile device(s) 404 may provide the determined location and unique identifier (e.g., a serial number) of monitoring device 100 to server(s) 404 via network 408. Alternatively, upon detecting signal 412, mobile device(s) 404 may provide their own location(s) (e.g., GPS coordinates) to server(s) 404. The location of mobile device(s) 404 may serve as an estimate of the location of monitoring device 100. The location information provided to server(s) 404 may be encrypted, for example, by mobile device(s) 402. Monitoring device 100 may not be configured to communicate with server(s) 404. Accordingly, mobile device(s) 402 act as relay devices for providing the location and unique identifier of monitoring device 100 to server(s) 404.

In an embodiment, the beacon may be a Bluetooth Low Energy (BLE)-based beacon and signal 412 may comprise a BLE-based signal. However, it is noted that other types of beacons may be utilized.

In an embodiment, server(s) 404 may form a network-accessible server set (e.g., a cloud-based environment or platform). Server(s) 404 may be accessible via network 408 (e.g., in a “cloud-based” embodiment) to build, deploy, and manage applications and services. Server(s) 404 may be co-located (e.g., housed in one or more nearby buildings with associated components such as backup power supplies, redundant data communications, environmental controls, etc.) to form a datacenter, or may be arranged in other manners. Accordingly, in an embodiment, server(s) 404 may be a datacenter in a distributed collection of datacenters.

Server(s) 404 may be configured to execute one or more software applications (or “applications”) and/or services. Server(s) 404 may also be configured for specific uses. For example, as shown in FIG. 4, server(s) 404 may be configured to execute a monitoring application 410. Monitoring application 410 may be configured to receive and/or decrypt the location information and unique identifier of monitoring device 100 received from mobile device(s) 402. Monitoring application 410 may be communicatively coupled to a database 418 that maps different unique identifiers to different wearer identifiers (e.g., the wearer's name) of monitoring devices (e.g., monitoring device 100). Upon obtaining the unique identifier from mobile device(s) 402, monitoring application 410 may query database 418 and obtain the wearer identifier based on the unique identifier. Monitoring application 410 may generate a user interface comprising a map indicating the location of monitoring device 100, along with displaying the wearer identifier. The location may be determined based on the location information received from mobile device(s) 402. The user interface may also specify an indication as to when the unique identifier and/or location information was received for monitoring device 100 from mobile device(s) 402. For instance, the user interface may display a first indication if the unique identifier and/or location information was received within 30 minutes from the last time the unique identifier and/or location information was received, may display a second indication if the location information was received more than 30 minutes, but less than 2 hours, from when the unique identifier and/or location information was last received, and may display a third indication if no location information was received more than 2 hours from when the unique identifier and/or location information was last received.

A user may access monitoring application 410 (and the user interface provided thereby) via computing device 406. As shown in FIG. 4, computing device 406 includes a display screen 412 and a browser 414. A user may access and/or utilize monitoring application 410 by interacting with an application at computing device 406 capable of accessing monitoring application 410. For example, the user may use browser 414 to traverse a network address (e.g., a uniform resource locator) to monitoring application 410, which invokes a user interface 416 (e.g., a web page) in a browser window rendered on computing device 406. By interacting with user interface 416, the user may invoke monitoring application 410. Computing device 406 may be any type of stationary device, such as a desktop computer or PC (personal computer), or mobile computing device (such as a laptop computer, a notebook computer, a tablet computer, etc.).

Examples of mobile device(s) 402 include, but are not limited to, a smart phone, a tablet computer, a laptop computer, a notebook computer, etc.

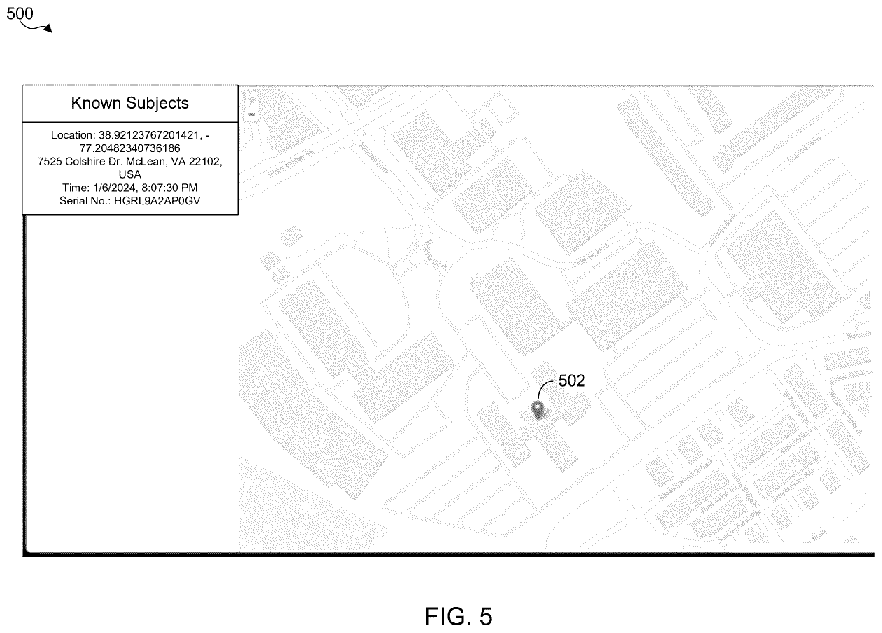

FIG. 5 depicts an example graphical user interface (GUI) screen 500 for monitoring a wearer of monitoring device 100, according to some embodiments. As shown in FIG. 5, GUI screen 500 depicts a map with a pinpoint 502 indicative of where monitoring device 100 is on the map. GUI screen 500 also depicts information associated with monitoring device 100, such as, but not limited to, the serial number of monitoring device 100, coordinates of monitoring device 100, an address that corresponds to the coordinates, the date and/or time at which the location of monitoring device 100 was detected (or when the unique identifier and/or location information was last received), etc.

### Additional Embodiments

In an embodiment in which transceiver(s) 210 include an NFC-based antenna, the wearer of monitoring device 100 may be required to periodically check-in at a particular location comprising an NFC reader. The wearer may position monitoring device 100 such that it is proximate to the NFC reader. The NFC reader may read information (e.g., the unique identifier) from monitoring device 100. Upon reading the unique identifier, a computing device communicatively coupled to NFC reader may provide the unique identifier and/or location information indicating a location of the NFC reader to server(s) 404 via network 408. Monitoring application 410 may determine whether the unique identifier was received from the computing device in accordance with a predetermined time period (e.g., every 30 days). If a unique identifier is not received within the predetermined time period, monitoring application 410 may generate an alert to an entity monitoring the wearer indicating that the wearer did not properly check-in.

In an embodiment, monitoring application 410 provides notifications to monitoring device 100 via mobile device(s) 402. For instance, based on the location determined for monitoring device 100, monitoring application 410 may identify mobile device(s) 402 in the vicinity of the determined location and transmit a notification to such mobile device(s) 402. When the mobile device(s) 402 are in proximity to monitoring device 100, mobile device(s) 402 may provide the notification to monitoring device 100. Upon receiving the notification (e.g., via transceiver(s) 210), processing circuit 202 of monitoring device 100 may perform one or more actions. Such action(s) include, but are not limited to, activating an LED or a vibration unit of output device(s) 206, playing a sound via a speaker of output device(s) 206, etc. In a particular embodiment, monitoring application 410 may not limit the transmission of the notification to mobile device(s) 402 that are in the vicinity of monitoring device 100. Instead, monitoring application 410 may provide the notification to any mobile device configured to receive such notifications regardless of its location. This way, when the wearer of monitoring device 102 eventually moves in vicinity of mobile device(s) 402, mobile device(s) 402 may provide the notification to monitoring device 102.

Method for Determining that a Monitoring Device has been Tampered with or Removed from a Limb of a Wearer of the Monitoring Device

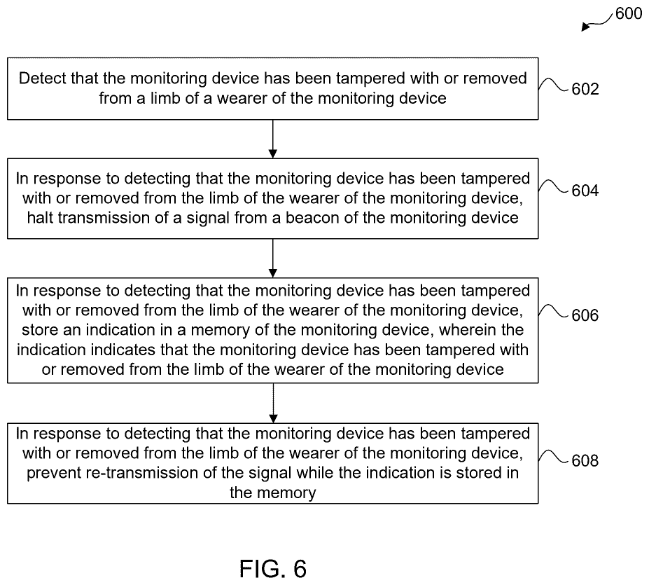

FIG. 6 is a flowchart for a method 600 for determining that a monitoring device has been tampered with or removed from a limb of a wearer of the monitoring device, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 1-4. However, method 600 is not limited to those example embodiments.

In 602, processing circuit 202 of monitoring device 100 may detect that the monitoring device has been tampered with or removed from a limb of a wearer of the monitoring device. In an embodiment, detecting that monitoring device 100 has been tampered with or removed from the limb of a wearer of monitoring device 100 comprises detecting (e.g., by processing circuit 202) that data received from at least one of one or more motion sensors of sensor(s) 212 or one or more physiological sensors of sensor(s) 212 meets (e.g., exceeds or falls below) a predetermined threshold. In another embodiment, detecting that monitoring device 100 has been tampered with or removed from the limb of a wearer of monitoring device 100 comprises determining (e.g., by processing circuit 202) that a component of monitoring device 100 has been removed. The component may comprise at least one of a battery (e.g., power source 214) of monitoring device 100 or a beacon (e.g., transceiver(s) 210) of monitoring device 100. In a further embodiment, detecting that monitoring device 100 has been tampered with or removed from the limb of a wearer of monitoring device 100 comprises determining (e.g., by processing circuit 202) that a conductive wire (e.g., wire(s) 302) that runs along a strap (e.g., first strap portion 104 and/or second strap portion 106) of monitoring device 100 has been cut.

In 604, in response to detecting that the monitoring device has been tampered with or removed from the limb of the wearer of the monitoring device, processing circuit 202 may halt (e.g., stop or suspend) transmission of a signal from a beacon (e.g., transceiver(s) 210) of monitoring device 100. In an embodiment, the beacon is a BLE-based beacon, and the signal is a BLE-based signal. It is noted that if, at step 602, transceiver(s) 210 are removed, step 604 may be bypassed.

In an embodiment, the signal comprises an identifier (e.g., a serial number of monitoring device 100) that uniquely identifies monitoring device 100.

In 606, in response to detecting that the monitoring device has been tampered with or removed from the limb of the wearer of the monitoring device, processing circuit 202 may store an indication in memory 204 of monitoring device 100, wherein the indication indicates that monitoring device 100 has been tampered with or removed from the limb of the wearer of monitoring device 100.

In an embodiment, a counter value stored in the memory is incremented each time the monitoring device is activated.

In 608, in response to detecting that the monitoring device has been tampered with or removed from the limb of the wearer of the monitoring device, processing circuit 202 may prevent re-transmission of the signal while the indication is stored in memory 204. For example, processing circuit 202 may not send a command to transceiver(s) 210 to resume transmission of the signal until the indication stored in memory 204 is reset.

In an embodiment, in response to detecting that the monitoring device has been tampered with or removed from the limb of the wearer of the monitoring device, processing circuit 202 may activate output device(s) 206 coupled to monitoring device 100.

In an embodiment, the output device comprises at least one of an LED, a vibration unit, or a speaker.

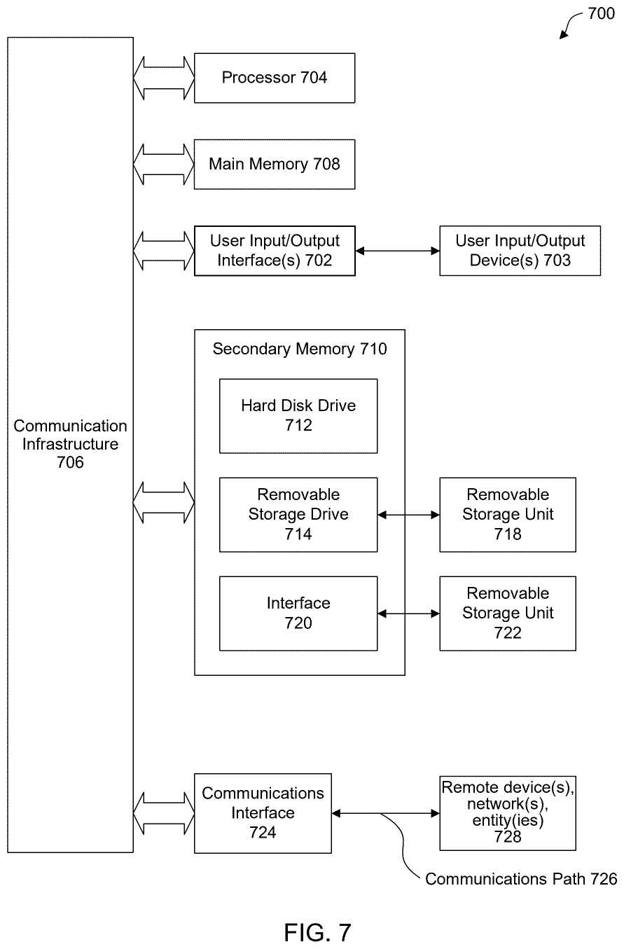

Various embodiments (e.g., monitoring device 100, mobile device(s) 402, server(s) 404, and/or computing device 406 may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards. In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
detecting that a monitoring device has been tampered with or removed from a limb of a wearer of the monitoring device; and
in response to detecting that the monitoring device has been tampered with or removed from the limb of the wearer of the monitoring device:
halting transmission of a signal from a beacon of the monitoring device;
storing an indication in a memory of the monitoring device, wherein the indication indicates that the monitoring device has been tampered with or removed from the limb of the wearer of the monitoring device; and
preventing re-transmission of the signal while the indication is stored in the memory.

2. The computer-implemented method of claim 1, further comprising:
in response to detecting that the monitoring device has been tampered with or removed from the limb of the wearer of the monitoring device, activating an output device coupled to the monitoring device.

3. The computer-implemented method of claim 2, wherein the output device comprises at least one of:
a light emitting diode (LED);
a vibration unit; or
a speaker.

4. The computer-implemented method of claim 1, wherein the beacon is a Bluetooth Low Energy (BLE)-based beacon, and wherein the signal is a BLE-based signal.

5. The computer-implemented method of claim 1, wherein the signal comprises an identifier that uniquely identifies the monitoring device.

6. The computer-implemented method of claim 1, wherein detecting that the monitoring device has been tampered with or removed from the limb of a wearer of the monitoring device comprises:
detecting that data received from at least one of one or more motion sensors or one or more physiological sensors meets a predetermined threshold.

7. The computer-implemented method of claim 1, wherein detecting that the monitoring device has been tampered with or removed from the limb of a wearer of the monitoring device comprises:
determining that a component of the monitoring device has been removed.

8. The computer-implemented method of claim 7, wherein the component comprises at least one of:
a battery of the monitoring device; or
a beacon of the monitoring device.

9. The computer-implemented method of claim 1, wherein detecting that the monitoring device has been tampered with or removed from the limb of a wearer of the monitoring device comprises:
determining that a conductive wire that runs along a strap of the monitoring device has been cut.

10. The computer-implemented method of claim 1, further comprising:
incrementing a counter value stored in the memory each time the monitoring device is activated.

11. A monitoring device, comprising:
a memory; and
at least one processor circuit configured to:
detect that the monitoring device has been tampered with or removed from a limb of a wearer of the monitoring device; and
in response to detecting that the monitoring device has been tampered with or removed from the limb of the wearer of the monitoring device:
halt transmission of a signal from a beacon of the monitoring device;
store an indication in a memory of the monitoring device, wherein the indication indicates that the monitoring device has been tampered with or removed from the limb of the wearer of the monitoring device; and
prevent re-transmission of the signal while the indication is stored in the memory.

12. The monitoring device of claim 11, wherein the at least one processor circuit is further configured to:
in response to detecting that the monitoring device has been tampered with or removed from the limb of the wearer of the monitoring device, activate an output device coupled to the monitoring device.

13. The monitoring device of claim 12, wherein the output device comprises at least one of:
a light emitting diode (LED);
a vibration unit; or
a speaker.

14. The monitoring device of claim 11, wherein the beacon is a Bluetooth Low Energy (BLE)-based beacon, and wherein the signal is a BLE-based signal.

15. The monitoring device of claim 11, wherein the signal comprises an identifier that uniquely identifies the monitoring device.

16. The monitoring device of claim 11, wherein, to detect that the monitoring device has been tampered with or removed from the limb of a wearer of the monitoring device, the at least one processor circuit is configured to:
detect that data received from at least one of one or more motion sensors or one or more physiological sensors meets a predetermined threshold.

17. The monitoring device of claim 11, wherein, to detect that the monitoring device has been tampered with or removed from the limb of a wearer of the monitoring device, the at least one processor circuit is configured to:
determine that a component of the monitoring device has been removed.

18. The monitoring device of claim 11, wherein, to detect that the monitoring device has been tampered with or removed from the limb of a wearer of the monitoring device, the at least one processor circuit is configured to:
determine that a conductive wire that runs along a strap of the monitoring device has been cut.

19. A non-transitory computer-readable storage medium having program instructions recorded thereon that, when executed by at least one processor circuit, perform a method, the method comprising:
detecting that a monitoring device has been tampered with or removed from a limb of a wearer of the monitoring device; and
in response to detecting that the monitoring device has been tampered with or removed from the limb of the wearer of the monitoring device:
halting transmission of a signal from a beacon of the monitoring device;
storing an indication in a memory of the monitoring device, wherein the indication indicates that the monitoring device has been tampered with or removed from the limb of the wearer of the monitoring device; and
preventing re-transmission of the signal while the indication is stored in the memory.

20. The non-transitory computer-readable storage medium of claim 19, the method further comprising:
in response to detecting that the monitoring device has been tampered with or removed from the limb of the wearer of the monitoring device, activating an output device coupled to the monitoring device.
